(19) United States
(12) Patent Application Publication
(10) Pub. No.: US 2011/0195647 A1
(43) Pub. Date: Aug. 11, 2011

(54) Device for removing the ribs from a piece of slaughtered animal

(76) Inventors: Joachim Schill, Kehl (DE); Hartmut Ilch, Kehl (DE)

(21) Appl. No.: 11/579,578

(22) PCT Filed: May 10, 2005
(86) PCT No.: PCT/DE2005/000872

§ 371 Date: Apr. 25, 2011

(30) Foreign Application Priority Data
May 11, 2004 (DE) 10 2004 023 733.6

(51) Int. Cl. A22C 17/00

(52) U.S. Cl. 452/135

(57) ABSTRACT

The invention relates to a device for removing individual ribs from a piece of slaughter animal whose spinal column was cut off. A conveying device aligns the piece on a cutting surface on which the spinal column was cut off and conveys the piece. A rib sensor (1) detects the position if the ribs near the cutting surface. A rib cutting element (8) is advanced to the rib by means of a drive and is displaced along the rib. A control controls the drive of the rib cutting element (8) in accordance with the position detected by the rib sensor (1).

### PRIOR ART

The invention relates to a device for removing ribs from a piece of a slaughtered animal, from which the spinal column has been removed.

After the spinal column has been removed from slaughtered animals, such as pigs, cattle or sheep, the individual ribs are removed. In practice, this is done manually with the help of a rib-cutting element, which has a U-shaped blade and a handle. The worker places the knife at the cut surface, at which the spinal column was removed, at one of the ribs and pulls the knife through that piece of the slaughtered animal. At the same time, a rib is removed from that piece. This procedure is repeated until all the ribs have been cut out. The procedure is therefore time consuming and requires much effort. Moreover, the danger of injury to the worker cannot be excluded.

A device for removing ribs from abdomen area is known from the prior art of the EP 0 469 680 B1. For this device, the piece of meat is fastened in a frame and a loop-shaped knife element removes the rib from the piece of meat with the help of a movable carrier. It has proven to be disadvantageous that the position of the ribs is not known and that the worker must therefore place the loop-like knife element by hand at the rib. Moreover, ribs have the property that they do not extend in a straight line and are not shaped uniformly. Moreover, ribs may have thickenings resulting from fractures. The loop-like knife element cannot follow such irregularities without problems.

The EP 0 971 595 B1 disclose a method and a device for removing the whole of the rib section from the remaining piece of the slaughtered animal. The meat between the ribs remains with the rib section. Such rib sections are used for grilling as spare ribs. The thickness of the rib section is determined with the help of an x-ray unit. This has the disadvantage that it is associated with high costs and harbors a certain health risk. It is not possible to remove individual ribs with the device described.

### THE INVENTION AND ITS ADVANTAGES

Compared to the prior art, the inventive device has the advantage that a rib sensor recognizes the position of the ribs in the vicinity of the cut surface, at which the spinal column was removed. The data determined is passed on to a control system, which controls the driving mechanism of a rib-cutting element. Moreover, the rib-cutting element is brought up to the cut surface of the piece of slaughtered animal and applied to one or several ribs. Subsequently, the rib-cutting element is pulled by the driving mechanism through the piece, until the rib or several ribs are released completely. In order to speed up the process, several rib-cutting elements may be provided for releasing several ribs simultaneously. The piece of slaughtered animal is disposed on a transporting device for alignment as well as for the transport.

According to an advantageous embodiment of the invention, a moving plate with a stop for the cut surface is provided as transporting device. The stop ensures that the pieces to be worked on are always aligned in the same manner. The device still requires the information whether the piece is from the left or the right side of the animal. This may be entered manually into the control system of the device or determined by means of a camera with image processing. The piece of slaughtered animal is aligned on the transporting device so that the ribs are on the surface of the side pointing upward.

According to a further advantageous embodiment of the invention, holding means for holding the piece of slaughtered animals, such as barbs or hold-down devices, are provided at the transporting device. These ensure that the piece of slaughtered animal does not change its position on the transporting device during the process of removing a rib, during which large forces act on the piece of slaughtered animal.

According to a further advantageous embodiment of the invention, a tactile rib sensor is provided. This consists of several needles, which are disposed in parallel in one or several rows next to one another. The rows of needles extend perpendicularly to the rib section close to the cut surface, at which the spinal column was removed. A needle driving mechanism presses the needles, which are acted upon with springs, into the piece of slaughtered animal. At the same time, the needles are applied to the piece of slaughtered animal close to the cut surface. The piece of slaughtered animal is aligned on the transporting device so that the ribs are at the surface of the side pointing upward and some of the needles strike the ribs directly. The force, with which the needles are pressed into the piece, is adjusted so that the needles can penetrate into the meat between the ribs, but not into the ribs. The distance between the needles essentially is less than the distance between two ribs. A camera with a device for image processing recognizes the positions of the ends of the needles averted from the points of the needles. Moreover, the needles, which have penetrated into the meat, have a position different from that of the needles, the points of which have come up against ribs. Accordingly, the position of the ribs can be deduced from the position of the ends of the needles. To begin with, the width of the ribs, the distances between the ribs and the distance between the starting position of the needles and the upwards pointing side of the ribs can be determined. The thickness of the ribs can be derived from the width of the ribs. Subsequently, the position, to which the rib cutting element must be guided by the driving mechanism, in order to remove the individual ribs from the piece, is determined from this data. The remaining course of the ribs in the piece need not be known in order to remove the ribs, since the rib-cutting element can follow the course with the holding device for the rib cutting element.

The length of the rows of needles can be selected so that the positions of several ribs near the face surface can be determined simultaneously.

According to a further advantageous embodiment of the invention, an optical rib sensor is provided with a camera and with a device for image processing. The camera takes a photograph of the side of the piece of slaughtered animal, pointing upward. This photograph is analyzed by means of an image processing device, so that the positions of the ribs, especially those near the cut surface of the piece, can be determined. The camera is designed so that it takes photographs in visible light, in the UV region or in the x-ray region. To improve image quality, the piece of slaughtered animal can be irradiated with x-rays, UV radiation or visible light. At the same time, care must be taken so that the temperature of the piece of slaughtered animal is not raised by the radiation.

According to a further advantageous embodiment of the invention a rib-cutting knife with a U-shaped blade is provided as rib-cutting element. The distance between the two legs of the blade is adapted to the width of the rib, which is to be released. Different rib-cutting knifes can be used, depending on the nature of the animal that is to be worked on. Advantageously, the two ends of the legs are fastened to a holding device for a rib-cutting element. High stability is achieved in this way.

According to a further advantageous embodiment of the invention, a loop of wire, a rope or cord is provided as the rib-cutting element. This loop, which consists of a stable material and is moved by the driving mechanism, can remove the rib from the meat just like a rib-cutting knife. Compared to a rib-cutting knife, a loop has the advantage that it is more flexible and can adapt better to the shape and the course of a rib.

According to a further advantageous embodiment of the invention, an elongated knife with a linear blade is provided as a rib-cutting element for cutting off a layer from the piece, which contains several ribs adjacent to one another and the meat between the ribs. This knife can also be disposed at the device in addition to a U-shaped rib-cutting knife or a loop, so that individual ribs as well as a layer with several ribs can be removed from the piece of slaughtered animal.

According to a further advantageous embodiment of the invention, a spring, which pulls the rib-cutting element against the rib, is provided for the rib-cutting element. By these means, it is achieved that the least possible amount of meat remains at the rib. In addition, this spring ensures that the rib-cutting element can follow the irregularities of the rib.

According to a further, advantageous embodiment of the invention, the holding device for rib-cutting element is mounted displaceably and/or rotatably. Advantageously, it is mounted over springs. By these means, it is achieved that the rib-cutting element can follow the irregular course of the ribs and cannot get hung up in the rib at thickenings or extreme curvatures.

According to a further, advantageous embodiment of the invention, a force/moment sensor is provided at the rib-cutting element. As soon as forces or torques, which exceed a specified limit, act upon the rib-cutting element, the control system of the driving mechanism of the rib-cutting element ensures that the direction of the rib-cutting element is changed. In this case, a displaceable or rotatable mounting of the holding device for the rib-cutting element is not necessary.

According to a further, advantageous embodiment of the invention, a probing knife is provided, which, in the direction of movement of the rib-cutting element, is disposed in front of the rib-cutting element. The probing knife has a flat, linear blade. The blade is disposed parallel to the direction of movement of the rib-cutting element. During the movement of the rib-cutting element through the piece of slaughtered animal, the probing knife is seated at the upwards pointing side of the rib. At the same time, it severs the periosteum at the rib. In the event that there still is lean meat above the rib, this meat is also severed by the probing knife. The probing knife is pressed with a specified force against the rib. The rib withstands this pressure. The softer cartilage, which adjoins the rib in the region of the breastbone, does not withstand the force and gives way. As a result, the probing knife moves downward. This movement of the probing knife is noted by means of a sensor. The control system concludes from this that the rib-cutting element has reached the end of the rib. The rib-cutting element is therefore moved some slight distance further into the piece, in order to make certain that the whole of the rib has been removed.

According to a further advantageous development of the invention, a cut-off knife is provided for severing the ends of the rib, facing the breast bone, from the piece of slaughtered animals. As soon as the sensor, disposed at the probing knife, has detected that the end of the rib has been reached and that the rib cutting element has been moved a specified distance further, the cut-off knife is pressed downward so that the end of the rib, facing the breastbone, is also cut off from the piece. The cut-off knife and the probing knife may be mounted in a common holding device. This holding device is mounted movably at the device, so that the cut-off knife can be pressed downward for cutting off the end of the rib facing the breastbone. According to a further, advantageous development of the invention, a movable clamping jaw for clamping the severed rib is provided at the holding device for the rib-cutting element or the holding device of the probing knife and the cut-off knife. As soon as the cut-off knife has severed the cartilage at the end of the rib, the clamping jaw is lowered from above onto the rib. With that, the rib is held from below by the rib-cutting element and from above by the clamping jaw. The rib is pulled out of the piece of slaughtered animal by raising the clamping jaw and the rib-cutting element. Subsequently, the rib can be transported away.

According to a further advantageous development of the invention, a hold-down device for the section of the rib, which has already been removed, is provided at the holding device for the rib-cutting element behind the rib-cutting element in the direction of motion. The already removed section of the rib has the tendency to curve upward out of the piece. However, this effect is undesirable, since, as a result, the position of the section of the rib still remaining in the piece, can also change. In order to counteract this, the section of the rib, already removed, is pressed downward by the hold-down device.

Further advantages and advantageous developments of the invention may be inferred from the drawing, the following description and the claims.

### DRAWING

An example of the inventive device, which is described in the following, is shown in the drawing, in which

FIG. 1 shows the device in a perspective representation from the front,

FIG. 2 shows the device in a perspective representation from the rear

FIG. 3 shows the device in a perspective representation from below 7

FIG. 4 shows the device in a side view

FIG. 5 shows a device in a view from above and

FIG. 6 shows the device in a view from the rear.

### DESCRIPTION OF THE EXAMPLE

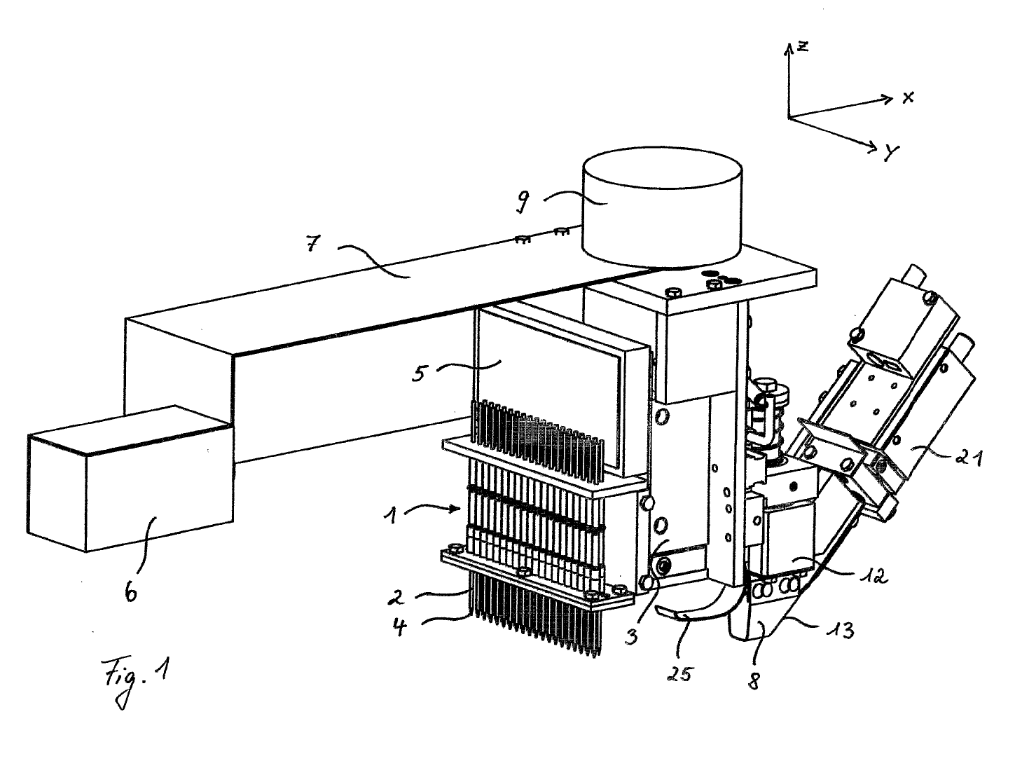

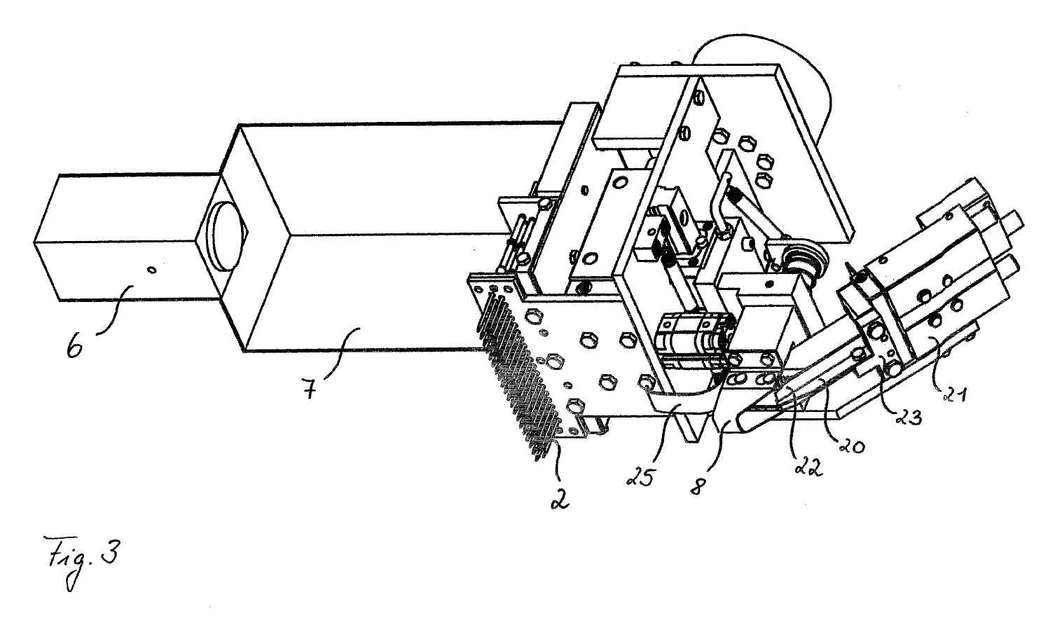

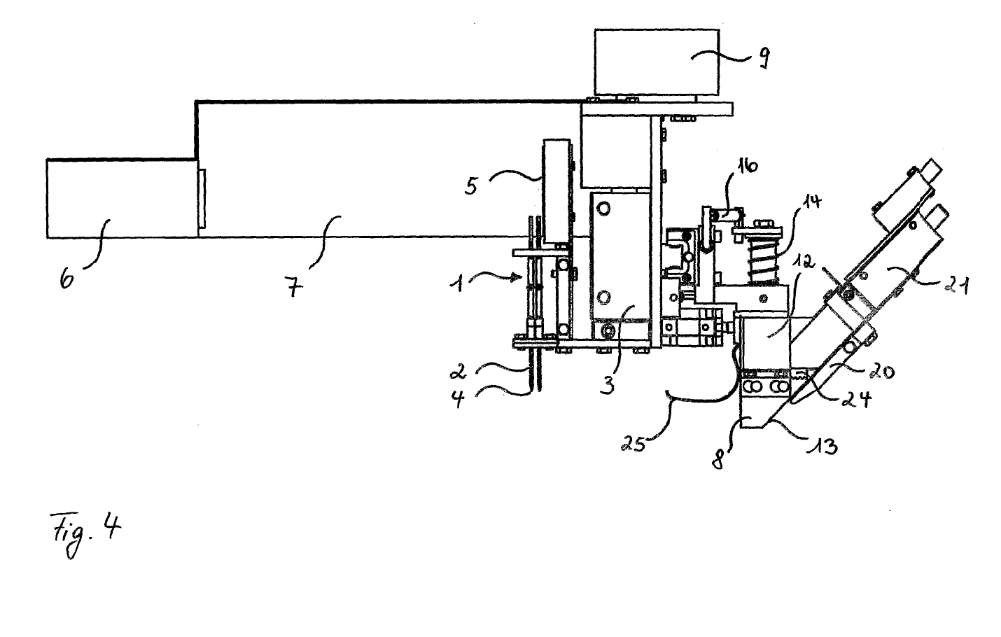

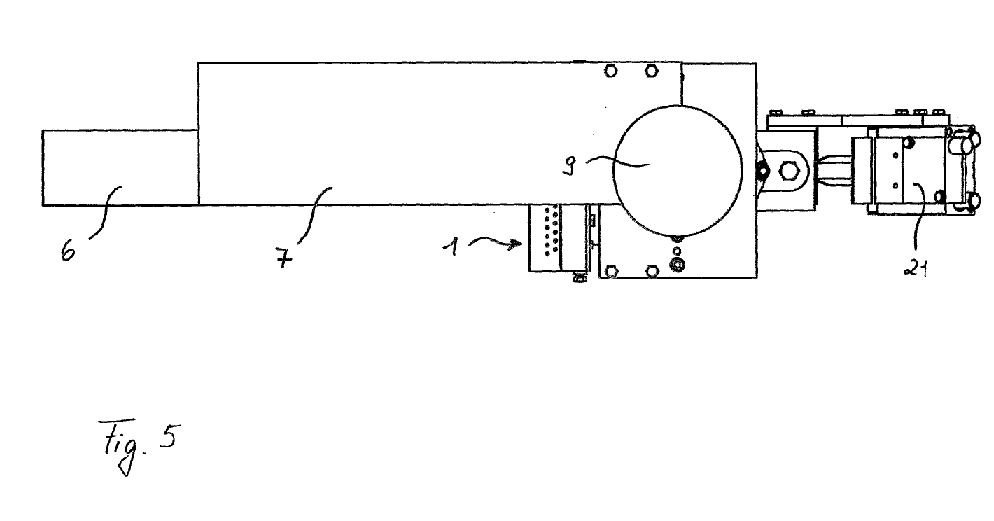

The device is shown in perspective views from different sides in FIGS. 1, 2 and 3. FIGS. 4, 5 and 6 show views from the side, from above and from the rear. In FIG. 1, the tactile sensor 1 with several needles 2, arranged in two rows next to one another, can be recognized in the foreground. The needle driving mechanism 3 moves the needles to the surface of a piece of slaughtered animal, which is not shown in the drawing, and presses to needles against the surface. As soon as the position of the ribs is determined, the needle driving mechanism 3 raises the needles once again. The points 4 of the needles 2 point downward. An illuminating device 5 is provided in the region of the ends of the needles 2, averted from the points of the needles and makes it easier to identify the positions of the ends of the needles with the help of a camera 6. In the starting state, the points 4 of the needles and, with that, also the adverted ends of the needles are at the same level. However, if the needles 2 are pressed by the needle driving mechanism 3 against the surface of a piece of slaughtered animal with ribs, which is not shown in the drawing, some of the needles can penetrate into the meat between the ribs, while the remaining needles are held back by the ribs. Thereby, the position of the needles is changed relative to one another. The upper ends of the needles in front of the illuminating device 5 are therefore located at different levels. The ends of the needles are photographed with the camera 6. This photograph is analyzed with the help of a device for processing images, not shown in the drawing. From the data so obtained, the position of the ribs in the piece of slaughtered animal in the vicinity of the cut surface, at which the spinal column was removed, is determined. The cover 7 is used for fastening the camera to the device and, moreover, shields the device against scattered light from the surroundings.

After the position of one or more ribs has been determined with the help of the tactile sensor 1, the U-shaped rib-cutting knife 8 is led up to one of the ribs in the region of the cut surface of the piece. For this purpose, the whole of the device is moved with the help of a driving mechanism, which is controlled by means of a control mechanism by using the positional data of the ribs, obtained with the help of the tactile sensor 1. The tasks of driving and controlling may also be taken over by a robot. With the adapter 9, the device is flanged to the driving mechanism or to the robot.

The control mechanism, the motor and the transporting device for transporting and aligning the piece of slaughtered animal are not shown in the drawing.

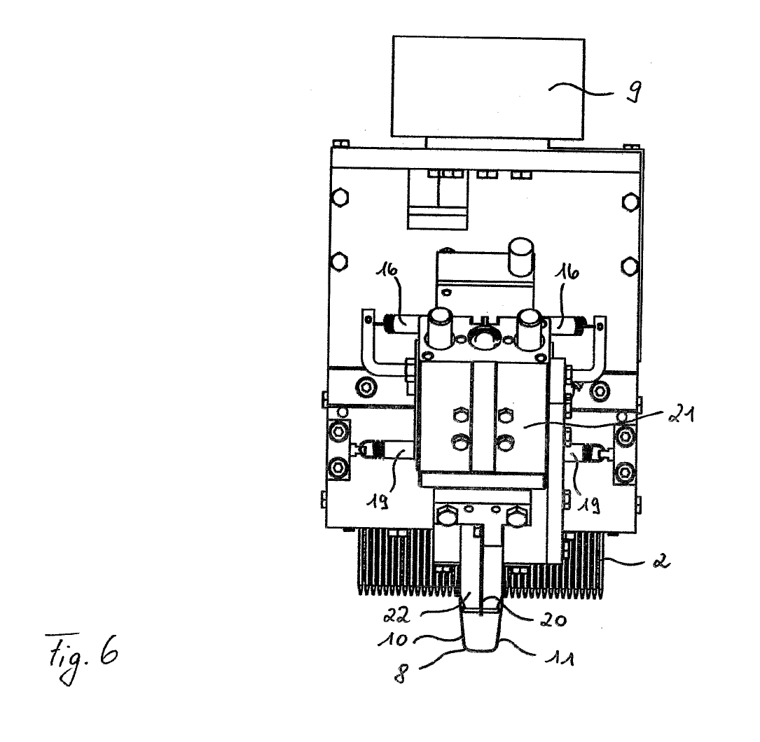

The U-shaped rib-cutting knife 8 is fastened with its two legs 10 and 11 at the holding device 12 for the rib-cutting element. The two legs 10 and 11 can be recognized in FIG. 6. The rib-cutting knife is beveled in the region of the sharp blade 13, so that it carries out a pulling cut in the direction of motion.

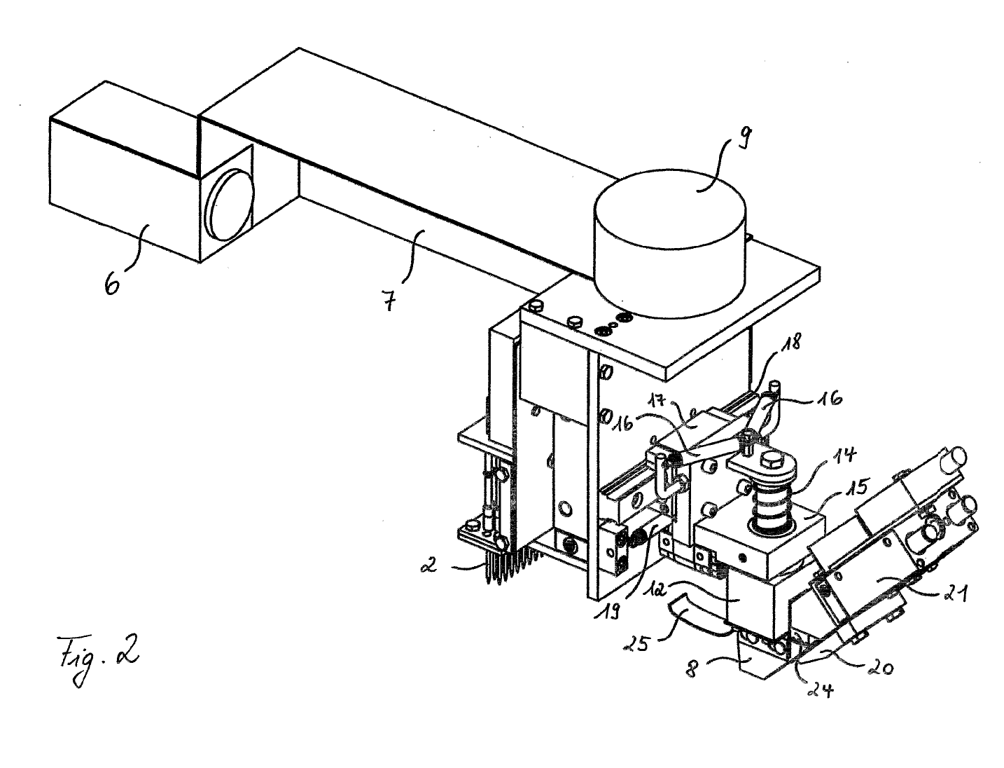

The holding device 12 for the rib-cutting element, with the springy tolerance equalization, can be recognized particularly well in FIG. 2. The spring 14 of the rib-cutting element ensures that the rib-cutting knife is pulled from below against the rib, which is to be removed. Thus, it is achieved that the least possible amount of meat remains adhering to the removed rib. Moreover, the spring 14 of the rib-cutting element equalizes irregularities in the rib in the z-direction. A coordinate system is indicated by arrows in FIG. 1. Said equalization relates to the direction labeled z in the coordinate system. Moreover, the holding device 12 for the rib-cutting element is mounted rotatably and displaceably. The springs 16 are deflected by a rotation of the holding device 12 for the rib-cutting element relative to the anchorage 15. The tolerance equalization is therefore springy and rotating about an axis, which extends parallel to the z axis. The anchorage 15, moreover, is mounted so that it can be shifted with a carriage 17 in a guide 18. The shifting causes the spring 19 to be deflected. Only one of the two springs 19 is shown in FIG. 2. The other spring can be recognized in FIG. 6. By these means, a springy, linear tolerance equalization of the rib-cutting knife in the y-direction is made possible.

During the removal of a rib, the rib-cutting knife is moved in the x-direction. In this direction, a probing knife 20 is disposed in front of the rib-cutting knife. This can be seen in FIGS. 2, 3 and 4. The blade of the probing knife points in the direction of movement and is rounded off at the tip. In the setting shown in the drawing, the probing knife is in a position, which is raised relative to the rib-cutting knife. In this setting, the rib-cutting knife is placed against the rib. Subsequently, the rib-cutting knife is pulled over a slight distance into the piece of the slaughtered animal. Only after this cut has been made, is the probing knife 20 brought along to the rib from above. The probing knife 20 is shifted by the lifting unit 21 in a direction parallel to the blade 13 of the rib-cutting knife. The probing knife 20 is used for severing the periosteum of the rib and any lean meat on the rib. In addition, the end of the rib, facing the breastbone, is recognized with the help of the probing knife.

The cut-off knife 22 is between the probing knife 20 and the rib-cutting knife 8. The probing knife 20 and the cut-off knife 22 are fastened in the same holding device 23. The tip of the probing knife 20 protrudes beyond the tip of the cut-off knife 22.

The force, with which the lifting unit 21 presses the probing knife against the surface of the rib, is adjusted so that the rib withstands the pressure but the cartilage, adjoining the rib in the region of the breastbone, does not. Therefore, when the probing knife reaches the cartilage, it is pressed downward by the force of the lifting unit. This movement is detected by a sensor at the lifting unit 21, which is not shown in the drawing. Thereupon, the force, with which the lifting unit presses the probing knife and the cut-off knife downward, is increased. At the same time, the cut-off knife and the probing knife are pressed downward by the lifting unit 21 relative to the rib-cutting knife 8, so that the cartilage of the rib is severed. This movement shifts a clamping jaw 24 downward. It ensures that the rib, which has already been removed, is clamped from below by the rib-cutting knife 8 and, from above, by the clamping jaw 24. In this way, the detached rib can be removed from the piece of meat.

The section of the rib, already removed, is pressed downward by the holding-down device 25.

All features of the invention, either individually or in any given combination, can be essential to the invention.

### LIST OF REFERENCE SYMBOLS

1 Tactile sensor
2 Needle
3 Needle driving mechanism
4 Point of the needle
5 Illuminating device of the needle ends
6 Camera
7 Cover
8 Rib-cutting knife
9 Adapter
10 Leg of the rib-cutting knife
11 Leg of the rib-cutting knife
12 Holding device for rib-cutting element
13 Blade of the rib-cutting knife
14 Spring of the rib-cutting element
15 Anchorage
16 Spring
17 Carriage
18 Guide
19 Spring
20 Probing knife
21 Lifting unit
22 Cut-off knife
23 Holding device
24 Clamping jaw
25 Hold-down device

1. A device for removing the ribs from a piece of a slaughtered animal, from which the spinal column has been removed,
with a transporting device for aligning the piece at the cut surface, at which the spinal column was removed and, for transporting the pieces,
with a rib sensor (1) in order to determine the position of the individual ribs in the vicinity of the cut surface,
with at least one rib-cutting element (8) for removing the ribs from the piece of slaughtered animal,
with a driving mechanism for the rib-cutting element, which moves the rib-cutting element (8) alongside the ribs at the cut surface of the piece and moves the rib-cutting element (8) along one or more of the ribs,
with a control mechanism, which controls the driving mechanism of the rib-cutting element (8) in accordance with the positions determined by the rib sensor (1).

2. The device of claim 1, characterized in that a movable plate with a stop for the cut surface is provided as transporting device.

3. The device of claim 1, characterized in that means for holding the pieces are provided at the transporting device.

4. The device of claim 1, characterized in that a tactile rib sensor (1) is provided with several needles (2), which are arranged in one or more rows next to one another.

5. The device of claim 4, characterized in that a needle driving mechanism (3) is provided, which presses the needles, on which the springs are acting, into the piece and subsequently raises said needles once again.

6. The device of claim 4, characterized in that a camera (6) and a device for image processing are provided for determining the position of the ends of the needles (2) averted from the points (4).

7. The device of one of the preceding claims, characterized in that an optical rib sensor is provided with a camera and a device for image processing.

8. The device of claim 7, characterized in that a source of radiation is provided for irradiating the piece with x-rays, UV radiation or visible light.

9. The device of claim 1, characterized in that a U-shaped rib cutting knife (8) is provided as rib-cutting element.

10. The device of claim 9, characterized in that the distance between the two legs (10,11) of the U-shaped rib-cutting knife is adapted to the width of the ribs to be removed.

11. The device of claim 1, characterized in that a loop of wire, a rope or a cord is provided as a rib-cutting element.

12. The device of claim 1, characterized in that a elongated knife with a linear blade is provided as a rib-cutting element for cutting off a layer from the piece, which contains several ribs adjacent to one another and the meat between the ribs.

13. The device of claim 1, characterized in that a spring (14) of the rib-cutting element is provided which pulls the rib-cutting element (8) against the rib.

14. The device of claim 1, characterized in that a holding device (12) for the rib-cutting element (8) is provided, and that the holding device (12) for the rib-cutting element is mounted so that it can be shifted and/or rotated.

15. The device of claim 14, characterized in that the holding device (12) for the rib-cutting element is mounted by springs (16, 19).

16. The device of claim 1, characterized in that a force/momentum sensor is provided at the rib-cutting element (8)

17. The device of claim 1, characterized in that a probing knife (20) is provided, which is disposed in front of the rib-cutting element (8) in the direction of motion of the rib-cutting element (8), that the probing knife (20) has a flat, linear blade, and that the blade is disposed parallel to the direction of motion of the rib-cutting element.

18. The device of claim 17, characterized in that the blade of the probing knife (20) is beveled or rounded off in the direction of motion.

19. The device of claim 17, characterized in that a sensor is provided at the probing knife (20) for determining the end of a rib facing the breastbone and of the junction of the rib and the breastbone cartilage.

20. The device of claim 1, characterized in that a cut-off knife (22) is provided for cutting off the end of the rib facing the breastbone of the slaughtered animal.

21. The device of claim 17, characterized in that the probing knife (20) and the cut-off knife (22) are mounted in a common holding device (23), and that the holding device is mounted movably at the holding device for the rib-cutting element (12).

22. The device of claim 14, characterized in that a movable clamping jaw (24) is provided at the holding device for the rib-cutting element (12) or at the holding device (23) of the probing knife (20) and the cut-off knife (22), for clamping the severed rib.

23. The device of claim 1, characterized in that a hold-down device (25) is provided at the holding device for the rib-cutting element (12) for holding down the already removed section of a rib.
